(19) United States
(12) Patent Application Publication
(10) Pub. No.: US 2024/0053984 A1
(43) Pub. Date: Feb. 15, 2024

(54) OPERATOR MIRRORING

(71) Applicant: International Business Machines Corporation, Armonk, NY (US)

(72) Inventors: Sudheesh S. Kairali, Kozhikode (IN); Subru S K, Ernakulam (IN); Sarbajit K. Rakshit, Kolkata (IN); Satyam Jakkula, BENGALURU (IN); Sudhanshu Sekher Sar, BANGALORE (IN)

(73) Assignee: International Business Machines Corporation, Armonk, NY (US)

(21) Appl. No.: 17/885,950

(22) Filed: Aug. 11, 2022

(51) Int. Cl. G06F 9/30; G06F 9/54

(52) U.S. Cl. CPC G06F 9/30007; G06F 9/542

(57) ABSTRACT

At a mirrored operator, a current operand snapshot is received from a source operator. The current operand snapshot comprises configuration data of a set of source operands managed by the source operator, and the set of source operands comprises at least one source operand. A set of mirrored operands is configured by the mirrored operator according to the current operand snapshot, resulting in a first configuration of the set of mirrored operands. At the mirrored operator, a change request is received from the source operator. The change request comprises a request to modify a configuration of the set of source operands. The first configuration of the set of mirrored operands is modified by the mirrored operator according to the change request.

### BACKGROUND

The present invention relates generally to a method, system, and computer program product for computing resource management. More particularly, the present invention relates to a method, system, and computer program product for operator mirroring.

An operator is a software application or application component that creates, configures, and manages instances of other applications and their components. An operator typically compares a desired state of a set of application components and their computing resources to an actual state, and performs reconfigurations to move the actual state closer to the desired state. An operator typically performs tasks such as backing up data, recovering from a failure, upgrading an application version, spawning additional instances of an application to process an increased number of transactions, and the like, automating software configuration and maintenance activities that are typically performed by a human operator. An operator provides one or more operands as a service. Each operand includes one or more workloads (applications or application components) and the managed computing resources on which the workloads execute. Operators are typically used as part of an application, workload, or microservice management system. Once example of a workload management system is Kubernetes. (Kubernetes is a registered trademark of The Linux Foundation in the United States and other countries.)

### SUMMARY

The illustrative embodiments provide a method, system, and computer program product. An embodiment includes a method that receives, from a source operator at a mirrored operator, a current operand snapshot, the current operand snapshot comprising configuration data of a set of source operands managed by the source operator, the set of source operands comprising at least one source operand. An embodiment configures, by the mirrored operator according to the current operand snapshot, a set of mirrored operands, the configuring resulting in a first configuration of the set of mirrored operands. An embodiment receives, from the source operator at the mirrored operator, a change request, the change request comprising a request to modify a configuration of the set of source operands. An embodiment modifies, by the mirrored operator according to the change request, the first configuration of the set of mirrored operands, the modifying resulting in a second configuration of the set of mirrored operands.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for operator mirroring in accordance with an illustrative embodiment;

FIG. 3 depicts a block diagram of an example configuration for operator mirroring in accordance with an illustrative embodiment;

FIG. 4 depicts an example of operator mirroring in accordance with an illustrative embodiment;

FIG. 5 depicts a continued example of operator mirroring in accordance with an illustrative embodiment;

FIG. 6 depicts a flowchart of an example process for operator mirroring in accordance with an illustrative embodiment;

FIG. 7 depicts a flowchart of another example process for operator mirroring in accordance with an illustrative embodiment.

### DETAILED DESCRIPTION

The illustrative embodiments recognize that many computing environments in which operators are used to manage operands are subject to security concerns, and thus implement restricted access. This restricted access makes it difficult for a third party computing environment manager to access the environment for debugging and support purposes. For example, if a customer reports that part of the computing environment is running unacceptably slowly, a third party manager contracted to provide support to that customer may be unable to determine the current configuration of the environment or access activity logs, due to the restricted access. Thus, the illustrative environments recognize that there is an unmet need to duplicate, or mirror, a computing environment's configuration in another, less restrictive environment, to enable troubleshooting and support of the original computing environment without comprising security.

The illustrative embodiments recognize that the presently available tools or solutions do not address these needs or provide adequate solutions for these needs. The illustrative embodiments used to describe the invention generally address and solve the above-described problems and other problems related to operator mirroring.

An embodiment can be implemented as a software application. The application implementing an embodiment can be configured as a modification of an existing workload management system, as a separate application that operates in conjunction with an existing workload management system, a standalone application, or some combination thereof.

Particularly, some illustrative embodiments provide a method that receives, from a source operator at a mirrored operator, a current operand snapshot, configures, by the mirrored operator according to the current operand snapshot, a set of mirrored operands, receives, from the source operator at the mirrored operator, a change request, and modifies, by the mirrored operator according to the change request, a configuration of the set of mirrored operands.

An embodiment implemented at a source operator (source operator embodiment) manages a set of source operands, using a presently known technique. As part of the management, a source operator embodiment uses a presently known technique to measure configuration data of the set of source operands. One source operator embodiment determines the configuration data in response to a command to do so. Another source operator embodiment determines the configuration data every time a predetermined time interval elapses, such as once every five minutes or once an hour. Another source operator embodiment determines the configuration data whenever a source operand's configuration changes, e.g. when a new application instance is deployed within a source operand or if a source operand experiences a storage resource failure and has a replacement storage resource deployed.

A source operator embodiment, executing in a source environment, assembles a current operand snapshot. The current operand snapshot includes sufficient configuration data of the set of source operands, at a particular time, to enable another operator to configure another set of operands sufficiently similarly to the set of source operands to enable troubleshooting and performance evaluation of the source operator and operands in another environment. For example, if source operand A is currently configured to run two instances of a particular application, each in its own container, the current operand snapshot would include data indicating that this is the current configuration of source operand A. Optionally, the current operand snapshot also includes sufficient source operator configuration data to configure another operator sufficiently similarly to the source operator to enable troubleshooting and performance evaluation of the source operator and operands in another environment.

One source operator embodiment uses a presently known technique to send a current operand snapshot to an embodiment implemented at a mirrored operator (mirrored operator embodiment) that has registered with an operator management system or computing environment management system to receive snapshots. Another source operator embodiment uses a presently known technique to broadcast a current operand snapshot to any mirrored operator embodiments configured to receive the broadcast. Another source operator embodiment uses another presently known technique to provide a current operand snapshot to a mirrored operator embodiment.

A mirrored operator embodiment is instantiated in a mirrored environment. In one mirrored operator embodiment, the mirrored environment is differently configured from the source environment in which a source operator embodiment executes. As one non-limiting example, the mirrored environment is accessible to users from a support organization, while the source environment is not accessible to users from the support organization, thus allowing users from the support organization to troubleshoot the source operator and its operands in an accessible environment. As another non-limiting example, the mirrored environment has a different configuration from the source environment to allow performance analysis of the source operator and its operands in a differently-configured environment. Some non-limiting examples of different configurations are different amounts of event logging between the source and mirrored environments and different numbers or types of resources in the source and mirrored environments. One mirrored operator embodiment registers with an operator management system or computing environment management system to receive a current operand snapshot, and thus receives the next-generated current operand snapshot. Another mirrored operator embodiment receives a broadcast current operand snapshot. Another mirrored operator embodiment receives a current operand snapshot using another presently known technique.

A mirrored operator embodiment configures a set of mirrored operands according to a received current operand snapshot. Because the snapshot includes sufficient configuration data of a set of source operands, at a particular time, to enable another operator to configure another set of operands sufficiently similarly to the set of source operands, after configuration the set of mirrored operands is ready for use in troubleshooting and performance evaluation of the source operator and operands in the mirrored operator embodiment's environment. For example, if a current operand snapshot indicated that source operand A is currently configured to run two instances of a particular application, each in its own container, mirrored operand A would also be configured to run two instances of the application, each in its own container.

A source operator embodiment receives a change request. A change request is a request to modify a configuration of the set of source operands. Some non-limited examples of a change request are a request to instantiate a new application instance on a new operand, a request to instantiate a new application instance on an existing source operand, a request to perform a software update on application instances running in all the source operands, and a request to remove an existing source operand from use. A source operator embodiment uses a presently known technique to perform the change request, modifying a configuration of the set of source operands.

One source operator embodiment uses a presently known technique to provide the change request to a mirrored operator embodiment that has registered with an operator management system, computing environment management system, or the source operator embodiment to receive change requests that pertain to a specific source operator. Another source operator embodiment uses a presently known technique to broadcast the change request to any mirrored operator embodiments configured to receive broadcast change requests that pertain to a specific source operator. Another source operator embodiment uses another presently known technique to provide a change request to a mirrored operator embodiment.

A mirrored operator embodiment that is mirroring a specific source operator receives a change request that pertains to the specific source operator. The mirrored operator embodiment uses a presently known technique to modify a configuration of the set of mirrored operands according to the change request. For example, if the change request was a request to instantiate a new application instance on an existing source operand, a mirrored operator embodiment instantiates a new application instance on the existing mirrored operand that is mirroring the existing source operand.

One mirrored operator embodiment also acts as a source operator embodiment, to relay a current operand snapshot and a change request to a second mirrored operator embodiment. For example, a first mirrored environment may be accessible to users from a support organization, while the source environment is not accessible to users from the support organization. A second mirrored environment is differently-configured from the first mirrored environment, and receives configuration data via the first mirrored environment, thus providing analysis access in a step-down fashion.

The manner of operator mirroring described herein is unavailable in the presently available methods in the technological field of endeavor pertaining to automated workload management. A method of an embodiment described herein, when implemented to execute on a device or data processing system, comprises substantial advancement of the functionality of that device or data processing system in receiving, from a source operator at a mirrored operator, a current operand snapshot, configuring, by the mirrored operator according to the current operand snapshot, a set of mirrored operands, receiving, from the source operator at the mirrored operator, a change request, and modifying, by the mirrored operator according to the change request, a configuration of the set of mirrored operands.

The illustrative embodiments are described with respect to certain types of operators, operands, broadcasts, snapshots, configurations, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

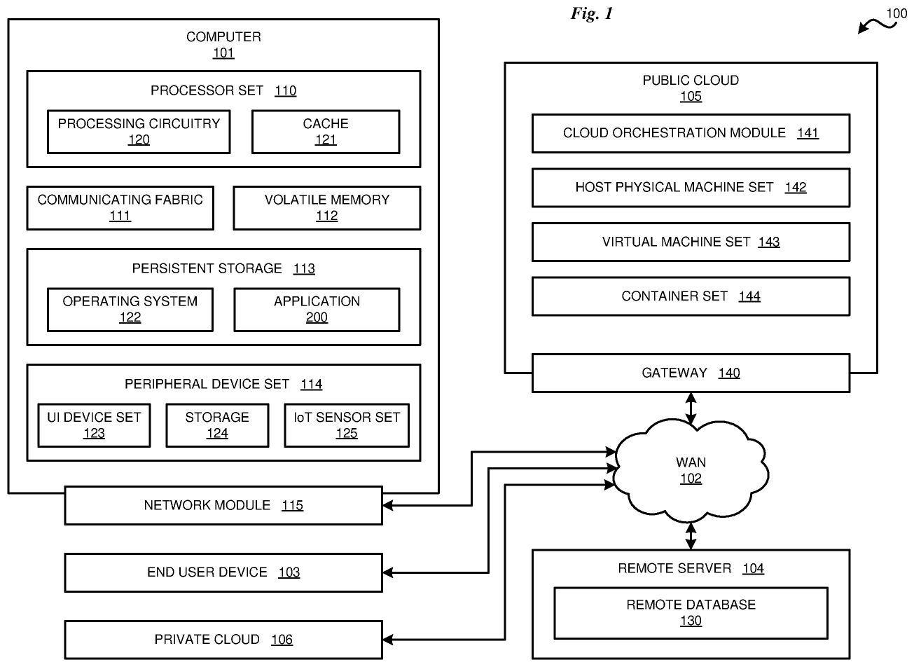

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a source operator embodiment or mirrored operator embodiment described herein. For example, one instance of application 200, implementing a source operator embodiment, communicates with another instance of application 200, implementing a mirrored operator embodiment and executing in another computer 101 within another instance of computing environment 100. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated. Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

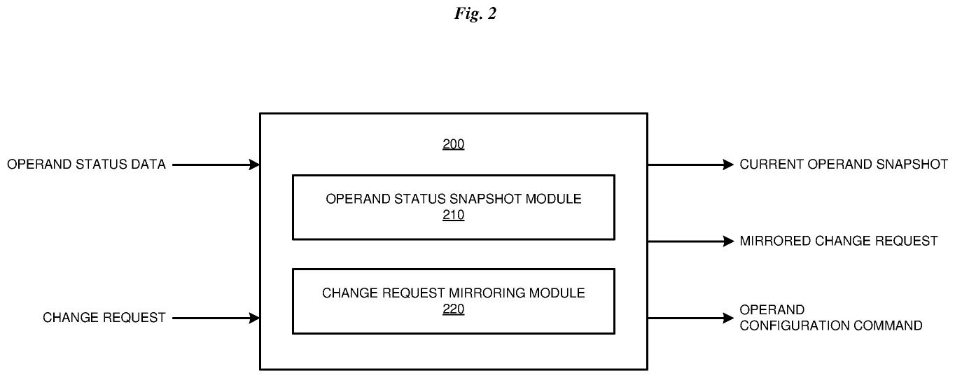

With reference to FIG. 2, this figure depicts a block diagram of an example configuration for operator mirroring in accordance with an illustrative embodiment. Application 200 is the same as application 200, implemented as a source operator embodiment, in FIG. 1.

Application 200 manages a set of source operands, using a presently known technique. As part of the management, application 200 uses a presently known technique to measure configuration data of the set of source operands. One implementation of application 200 determines the configuration data in response to a command to do so. Another implementation of application 200 determines the configuration data every time a predetermined time interval elapses, such as once every five minutes or once an hour. Another implementation of application 200 determines the configuration data whenever a source operand's configuration changes, e.g. when a new application instance is deployed within a source operand or if a source operand experiences a storage resource failure and has a replacement storage resource deployed.

Operand status snapshot module 210, executing in a source environment, assembles a current operand snapshot. The current operand snapshot includes sufficient configuration data of the set of source operands, at a particular time, to enable another operator to configure another set of operands sufficiently similarly to the set of source operands to enable troubleshooting and performance evaluation of the source operator and operands in another environment. For example, if source operand A is currently configured to run two instances of a particular application, each in its own container, the current operand snapshot would include data indicating that this is the current configuration of source operand A.

One implementation of module 210 uses a presently known technique to send a current operand snapshot to a mirrored operator embodiment that has registered with an operator management system or computing environment management system to receive snapshots. Another implementation of module 210 uses a presently known technique to broadcast a current operand snapshot to any mirrored operator embodiments configured to receive the broadcast. Another implementation of module 210 uses another presently known technique to provide a current operand snapshot to a mirrored operator embodiment.

Change request mirroring module 220 receives a change request, i.e. a request to modify a configuration of the set of source operands. Some non-limited examples of a change request are a request to instantiate a new application instance on a new operand, a request to instantiate a new application instance on an existing source operand, a request to perform a software update on application instances running in all the source operands, and a request to remove an existing source operand from use. Module 220 uses a presently known technique to perform the change request, modifying a configuration of the set of source operands.

One implementation of module 220 uses a presently known technique to provide the change request to a mirrored operator embodiment that has registered with an operator management system, computing environment management system, or the source operator embodiment to receive change requests that pertain to a specific source operator. Another implementation of module 220 uses a presently known technique to broadcast the change request to any mirrored operator embodiments configured to receive broadcast change requests that pertain to a specific source operator. Another implementation of module 220 uses another presently known technique to provide a change request to a mirrored operator embodiment.

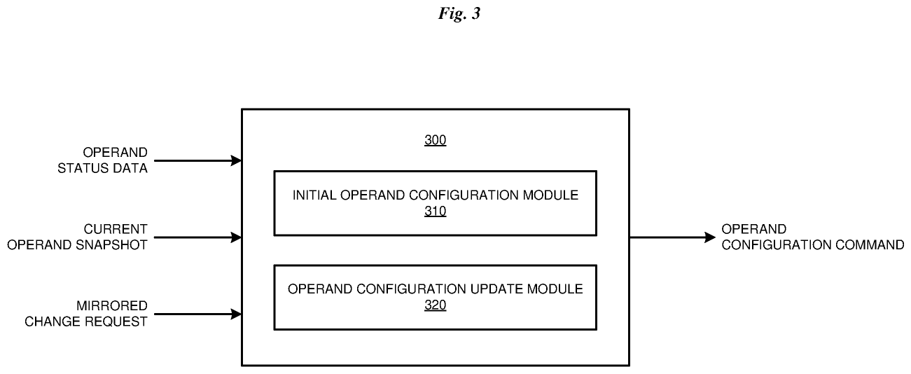

With reference to FIG. 3, this figure depicts a block diagram of an example configuration for operator mirroring in accordance with an illustrative embodiment. Application 300 is another instance of application 200 in FIG. 1, implemented as a mirrored operator embodiment.

Application 300 is instantiated in a mirrored environment. In one implementation of application 300, the mirrored environment is differently configured from the source environment in which a source operator embodiment (e.g. application 200) executes. As one non-limiting example, the mirrored environment is accessible to users from a support organization, while the source environment is not accessible to users from the support organization, thus allowing users from the support organization to troubleshoot the source operator and its operands in an accessible environment. As another non-limiting example, the mirrored environment has a different configuration from the source environment to allow performance analysis of the source operator and its operands in a differently-configured environment, such as an environment with a different amount of event logging or a different number or type of resources. One implementation of application 300 registers with an operator management system or computing environment management system to receive a current operand snapshot, and thus receives the next-generated current operand snapshot. Another implementation of application 300 receives a broadcast current operand snapshot. Another implementation of application 300 receives a current operand snapshot using another presently known technique.

Initial operand configuration module 310 configures a set of mirrored operands according to a received current operand snapshot. Because the snapshot includes sufficient configuration data of a set of source operands, at a particular time, to enable another operator to configure another set of operands sufficiently similarly to the set of source operands, after configuration the set of mirrored operands is ready for use in troubleshooting and performance evaluation of the source operator and operands in the mirrored operator embodiment's environment. For example, if a current operand snapshot indicated that source operand A is currently configured to run two instances of a particular application, each in its own container, mirrored operand A would also be configured to run two instances of the application, each in its own container.

Operand configuration update module 320, mirroring a specific source operator receives a change request that pertains to the specific source operator. Module 320 modifies a configuration of the set of mirrored operands according to the change request. For example, if the change request was a request to instantiate a new application instance on an existing source operand, a mirrored operator embodiment instantiates a new application instance on the existing mirrored operand that is mirroring the existing source operand.

One implementation of application 300 also acts as an implementation of application 200, to relay a current operand snapshot and a change request to a second instance of application 300.

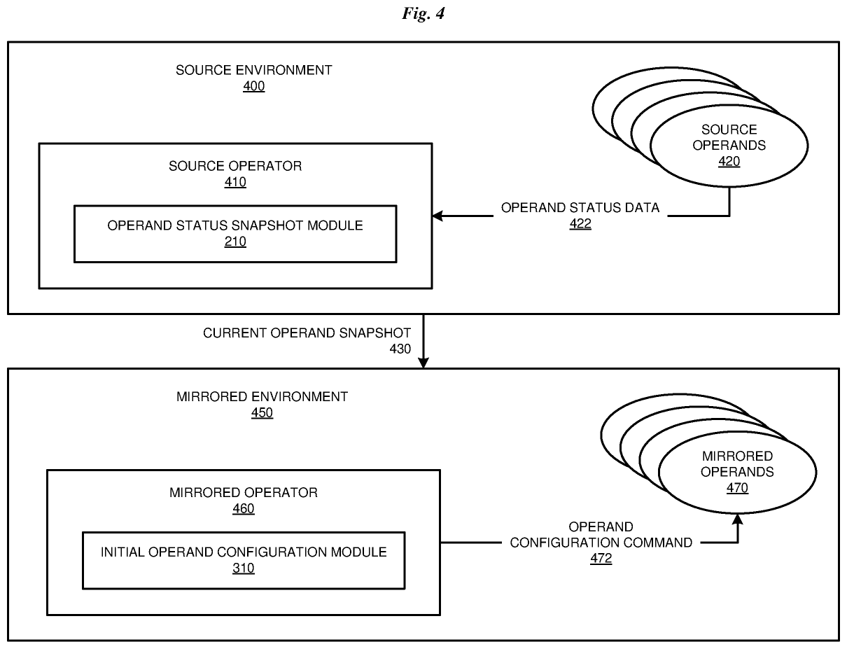

With reference to FIG. 4, this figure depicts an example of operator mirroring in accordance with an illustrative embodiment. Operand status snapshot module 210 is the same as operand status snapshot module 210 in FIG. 2. Initial operand configuration module 310 is the same as initial operand configuration module 310 in FIG. 3.

As depicted, operand status snapshot module 210, executing within source operator 410 in source environment 400, manages a set of source operands 420. In particular, module 210 measures configuration data of source operands 420, resulting in operand status data 422. Module 210 uses operand status data 422 to assemble current operand snapshot 430.

Initial operand configuration module 310 is instantiated within mirrored operator 460 in mirrored environment 450. Module 310 receives current operand snapshot 430 and, via operand configuration command 472, configures a set of mirrored operands 470 according to current operand snapshot 430. Because snapshot 430 includes sufficient configuration data of source operands 420, at a particular time, to enable mirrored operator 460 to configure mirrored operands 470 sufficiently similarly to source operands 420, after configuration the mirrored operands 470 are ready for use in troubleshooting and performance evaluation of source operator 410 and operands 420 in mirrored environment 450.

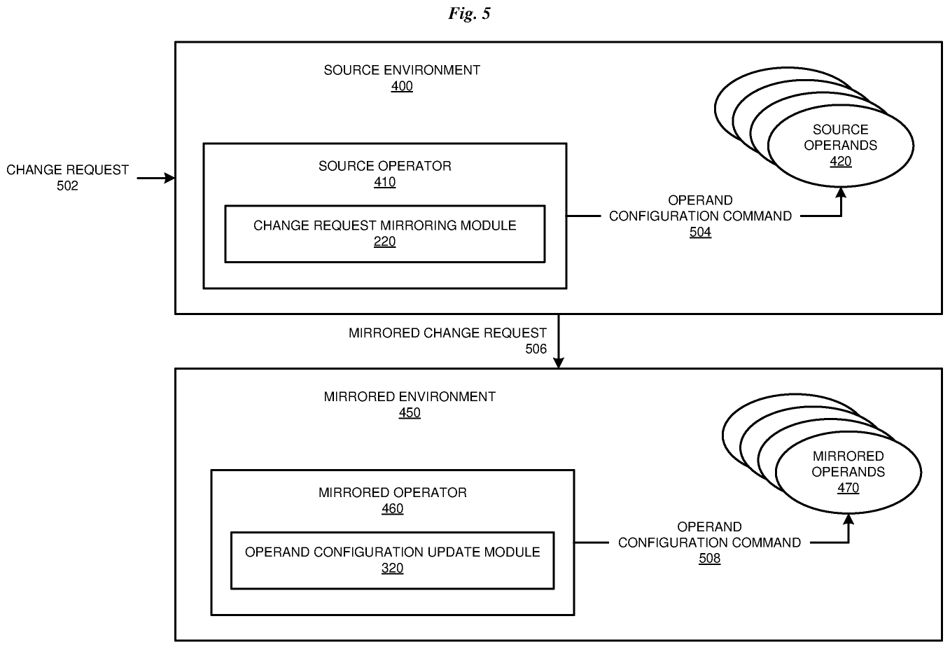

With reference to FIG. 5, this figure depicts a continued example of operator mirroring in accordance with an illustrative embodiment. Change request mirroring module 220 is the same as change request mirroring module 220 in FIG. 2. Operand configuration update module 320 is the same as operand configuration update module 320 in FIG. 3. Source environment 400, source operator 410, source operands 420, mirrored environment 450, mirrored operator 460, and mirrored operands 470 are the same as source environment 400, source operator 410, source operands 420, mirrored environment 450, mirrored operator 460, and mirrored operands 470 in FIG. 4.

Change request mirroring module 220 receives and performs change request 502, a request to modify a configuration of the set of source operands 420. Module 220 provides mirrored change request 506 to operand configuration update module 320. Module 220 uses operand configuration command 508 to modify a configuration of the set of mirrored operands 470 according to mirrored change request 506.

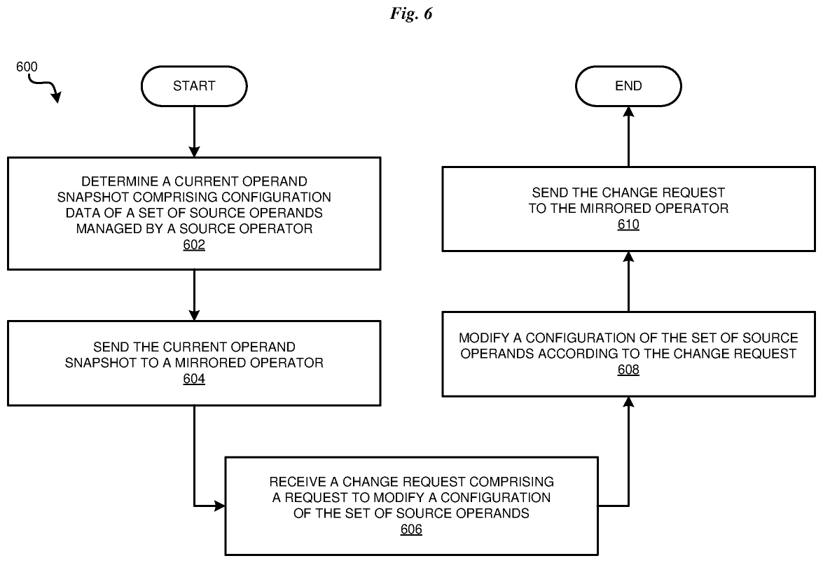

With reference to FIG. 6, this figure depicts a flowchart of an example process for operator mirroring in accordance with an illustrative embodiment. Process 600 can be implemented in application 200 in FIG. 2.

In block 602, the application determines a current operand snapshot comprising configuration data of a set of source operands managed by a source operator. In block 604, the application sends the current operand snapshot to a mirrored operator. In block 606, the application receives a change request comprising a request to modify a configuration of the set of source operands. In block 608, the application modifies a configuration of the set of source operands according to the change request. In block 610, the application sends the change request to the mirrored operator. Then the application ends.

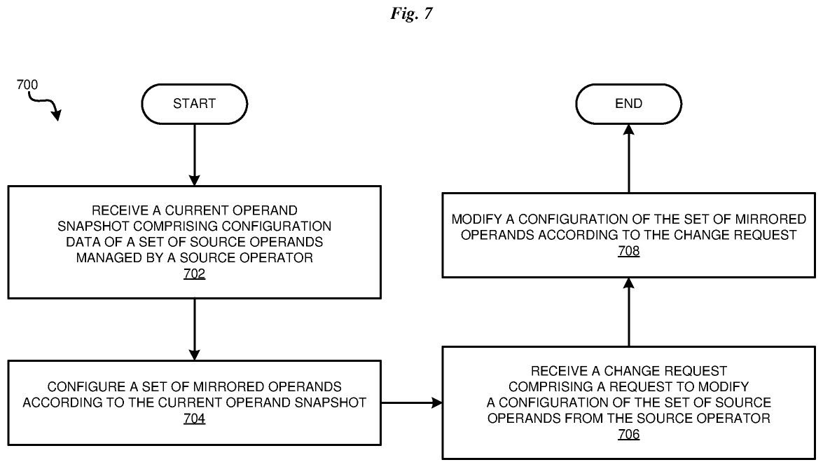

With reference to FIG. 7, this figure depicts a flowchart of another example process for operator mirroring in accordance with an illustrative embodiment. Process 700 can be implemented in application 300 in FIG. 3.

In block 702, the application receives a current operand snapshot comprising configuration data of a set of source operands managed by a source operator. In block 704, the application configures a set of mirrored operands according to the current operand snapshot. In block 706, the application receives a change request comprising a request to modify a configuration of the set of source operands from the source operator. In block 708, the application modifies a configuration of the set of mirrored operands according to the change request. Then the application ends.

Thus, a computer implemented method, system or apparatus, and computer program product are provided in the illustrative embodiments for operator mirroring and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving, from a source operator at a mirrored operator, a current operand snapshot, the current operand snapshot comprising configuration data of a set of source operands managed by the source operator, the set of source operands comprising at least one source operand;
configuring, by the mirrored operator according to the current operand snapshot, a set of mirrored operands, the configuring resulting in a first configuration of the set of mirrored operands;
receiving, from the source operator at the mirrored operator, a change request, the change request comprising a request to modify a configuration of the set of source operands; and
modifying, by the mirrored operator according to the change request, the first configuration of the set of mirrored operands, the modifying resulting in a second configuration of the set of mirrored operands.

2. The computer-implemented method of claim 1, further comprising:
registering to receive the current operand snapshot.

3. The computer-implemented method of claim 1, wherein the current operand snapshot is received via a first broadcast.

4. The computer-implemented method of claim 1, further comprising:
registering to receive the change request.

5. The computer-implemented method of claim 1, wherein the change request is received via a second broadcast.

6. The computer-implemented method of claim 1, wherein the source operator executes in a source environment and the mirrored operator executes in a mirrored environment, and wherein the source environment and the mirrored environment are not configured identically.

7. The computer-implemented method of claim 1, wherein the source operator executes in a source environment and the mirrored operator executes in a mirrored environment, and wherein the source environment is inaccessible to a support organization and the mirrored environment is accessible to the support organization.

8. The computer-implemented method of claim 1, wherein the mirrored operator provides the current operand snapshot to a second mirrored operator executing in a second mirrored environment.

9. The computer-implemented method of claim 1, wherein the mirrored operator provides the change request to a second mirrored operator executing in a second mirrored environment.

10. A computer program product for operator mirroring, the computer program product comprising:
one or more computer readable storage media, and program instructions collectively stored on the one or more computer readable storage media, the stored program instructions comprising:
program instructions to receive, from a source operator at a mirrored operator, a current operand snapshot, the current operand snapshot comprising configuration data of a set of source operands managed by the source operator, the set of source operands comprising at least one source operand;
program instructions to configure, by the mirrored operator according to the current operand snapshot, a set of mirrored operands, the configuring resulting in a first configuration of the set of mirrored operands;
program instructions to receive, from the source operator at the mirrored operator, a change request, the change request comprising a request to modify a configuration of the set of source operands; and
program instructions to modify, by the mirrored operator according to the change request, the first configuration of the set of mirrored operands, the modifying resulting in a second configuration of the set of mirrored operands.

11. The computer program product of claim 10, the stored program instructions further comprising:
program instructions to register to receive the current operand snapshot.

12. The computer program product of claim 10, wherein the current operand snapshot is received via a first broadcast.

13. The computer program product of claim 10, the stored program instructions further comprising:
program instructions to register to receive the change request.

14. The computer program product of claim 10, wherein the change request is received via a second broadcast.

15. The computer program product of claim 10, wherein the source operator executes in a source environment and the mirrored operator executes in a mirrored environment, and wherein the source environment and the mirrored environment are not configured identically.

16. The computer program product of claim 10, wherein the source operator executes in a source environment and the mirrored operator executes in a mirrored environment, and wherein the source environment is inaccessible to a support organization and the mirrored environment is accessible to the support organization.

17. The computer program product of claim 10, wherein the stored program instructions are stored in the at least one of the one or more storage media of a local data processing system, and wherein the stored program instructions are transferred over a network from a remote data processing system.

18. The computer program product of claim 10, wherein the stored program instructions are stored in the at least one of the one or more storage media of a server data processing system, and wherein the stored program instructions are downloaded over a network to a remote data processing system for use in a computer readable storage device associated with the remote data processing system.

19. The computer program product of claim 10, wherein the computer program product is provided as a service in a cloud environment.

20. A computer system comprising one or more processors, one or more computer-readable memories, and one or more computer-readable storage media, and program instructions stored on at least one of the one or more storage media for execution by at least one of the one or more processors via at least one of the one or more memories, the stored program instructions comprising:
program instructions to receive, from a source operator at a mirrored operator, a current operand snapshot, the current operand snapshot comprising configuration data of a set of source operands managed by the source operator, the set of source operands comprising at least one source operand;
program instructions to configure, by the mirrored operator according to the current operand snapshot, a set of mirrored operands, the configuring resulting in a first configuration of the set of mirrored operands;
program instructions to receive, from the source operator at the mirrored operator, a change request, the change request comprising a request to modify a configuration of the set of source operands; and
program instructions to modify, by the mirrored operator according to the change request, the first configuration of the set of mirrored operands, the modifying resulting in a second configuration of the set of mirrored operands.
